(19) United States
(12) Patent Application Publication
(10) Pub. No.: US 2021/0069538 A1
(43) Pub. Date: Mar. 11, 2021

(54) AUTOMATED SELF-TARGETING FIRE SUPPRESSION SYSTEMS AND METHODS

(71) Applicant: Tyco Fire Products LP, Lansdale, PA (US)

(72) Inventors: Zachary L. MAGNONE, Warwick, RI (US); Pedriant PENA, Berkley, MA (US); Rickard Bror Gunnargård, Ytterby (SE); Mattias EGGERT, Göteborg (SE)

(21) Appl. No.: 17/040,411

(22) PCT Filed: Mar. 22, 2019
(86) PCT No.: PCT/US2019/023667

§ 371 Date: Sep. 22, 2020

Related U.S. Application Data
(60) Provisional application No. 62/647,309, filed on Mar. 23, 2018.

(51) Int. Cl. A62C 37/36

(52) U.S. Cl. CPC A62C 37/36; A62C 3/06

(57) ABSTRACT

A fire suppression system can include at least two fire detectors arranged to scan a protected surface from different vantage points, a fire monitor that provides a fire suppression stream to the protected surface, and a fire suppression controller. The fire suppression controller receives the signal from each fire detector and causes the fire monitor to provide the fire suppression stream to the protected surface at a target location on the protected surface that is offset from the location of the fire by an offset value.

### CROSS-REFERENCE TO RELATED APPLICATIONS

The present disclosure claims the benefit of and priority to U.S. Provisional Application No. 62/647,309, titled “AUTOMATED SELF-TARGETING FIRE SUPPRESSION SYSTEM,” filed Mar. 23, 2018, the disclosure of which is incorporated herein by reference in its entirety.

### BACKGROUND

High-rise building exterior walls are at risk of fire events spreading from the interior space to the exterior of the building. Once at the exterior wall of the building, the fire can spread rapidly, especially in cases where there the external cladding contains combustible materials such as, for example, aluminum composite (ACM) panels.

### SUMMARY

At least one aspect relates to an automated fire suppression system. The system can include at least two fire detectors, a fire monitor, and a fire suppression controller. The at least two fire detectors can scan a protected surface from different vantage points, and output a signal corresponding to a location of a fire responsive to detecting the fire, the protected surface disposed on at least a portion of a vertical side of a structure. The fire monitor can provide a fire suppression stream to the protected surface. The fire suppression controller can be connected to the fire monitor and the at least two fire detectors and can receive the signal from each fire detector, determine a location of the fire on the protected surface relative to the fire monitor, determine a target location for the fire suppression stream on the protected surface, the target location offset from the location of the fire by an offset value, cause the fire monitor to provide the fire suppression stream to the protected surface responsive to receiving the signal from the at least two fire detectors, and cause the fire monitor to adjust at least one of a vertical discharge angle and a lateral direction of the fire suppression stream from to direct the fire suppression stream to the target location based on a spray impact region of the fire suppression stream.

At least one aspect relates to a method of automated fire suppression. The method can include scanning a protected surface from at least two different vantage points, the protected surface disposed on at least a portion of a vertical side of a structure, receiving at least one signal corresponding to a fire based on the scanning, determining a location of the fire on the protected surface relative to a source of a fire suppression stream, determining a target location for the fire suppression stream on the protected surface, the target location offset from the location of the fire by an offset value to cool the protected surface, providing the fire suppression stream to the protected surface responsive to the at least one signal indicating the fire is detected, and adjusting at least one of a vertical discharge angle and a lateral direction of the fire suppression stream such that the fire suppression stream is directed to the target location based on a spray impact region of the fire suppression stream.

At least one aspect relates to an automated fire suppression system. The system can include at least two fire detectors, a fire monitor, and a fire suppression controller. The at least two fire detectors can scan a protected surface from different vantage points, and output a signal corresponding to a location of a fire responsive to detecting the fire, the protected surface disposed on at least a portion of a vertical side of a structure. The fire monitor can provide a fire suppression stream to the protected surface. The fire suppression controller can be connected to the fire monitor and the at least two fire detectors and can receives the signal from each fire detector, determine a location of the fire on the protected surface relative to the fire monitor, determine a target location for the fire suppression stream on the protected surface, provide the fire suppression stream to the protected surface responsive to the signal from the at least two fire detectors indicating the fire is detected, adjust at least one of a vertical discharge angle and a lateral direction of the fire suppression stream from the fire monitor such that the fire suppression stream is directed to the target location, and adjust a setting of the spray angle of the fire monitor nozzle based on a distance from the location of the fire to the fire monitor based on a spray impact region of the fire suppression stream.

At least one aspect relates to a method of automated fire suppression. The method can include scanning a protected surface from at least two different vantage points, the protected surface disposed on at least a portion of a vertical side of a structure, receiving at least one signal corresponding to a fire based on the scanning, determining a location of the fire on the protected surface relative to a source of a fire suppression stream, determining a target location for the fire suppression stream on the protected surface, providing the fire suppression stream to the protected surface responsive to the at least one signal indicating the fire is detected, adjusting at least one of a vertical discharge angle and a lateral direction of the fire suppression stream such that the fire suppression stream is directed to the target location and cools the protected surface, and adjusting a spray angle of the fire suppression stream based on a distance from the location of the fire to the fire monitor based on a spray impact region of the fire suppression stream.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a schematic diagram of a fire suppression system.

FIG. 2 is a schematic diagram of a sensor array.

FIGS. 3A and 3B are schematic diagrams of a mounting arrangement of a fire suppression system.

FIG. 4 is a block diagram of a fire monitor control system.

FIG. 5 is a schematic diagram of a spray angle of a fire suppression stream discharged from a nozzle of a fire monitor.

FIG. 6 is a schematic diagram of a spray impact region.

FIG. 7 is a schematic diagram of a fire suppression system.

### DETAILED DESCRIPTION

Following below are more detailed descriptions of various concepts related to, and implementations of fire suppression systems and methods. Fire suppression systems can be used to address fires, including fires on the outside of a building. For example, fire suppression systems can be used to automatically detect a fire on the exterior of a building and target the fire with a fire suppression stream from a fire monitor. Building codes in many countries may require the use of cladding material that meet the local fire rating standards and/or find a fire suppression solution.

Fire suppression solutions can activate sprinkler systems in the interior of buildings based on heat and/or smoke detection. In addition, an alarm can also be activated to alert firefighters so that they can respond to the fire. However, the interior sprinkler system may not always prevent the fire from spreading to the exterior of the building and the response of firefighters can be delayed to a point where the fire is out of control. In addition, if the fire starts on the outside of the building, the automated sprinkler/alarm systems may not be helpful because the automated sprinkler/alarm systems may be designed to protect the interior space. In such cases, the firefighters may not be able to respond until someone manually activates the alarm.

Some fire suppression systems directs the water stream from the fire nozzle directly at the fire. However, such a targeting approach may be insufficient to appropriately cool the cladding material and contain rapid growth of such fires. Fire suppression systems in accordance with the present disclosure can implement a targeting approach that addresses the vertical orientation of the exterior of the building and the rapid growth of the fire upon melting of cladding material.

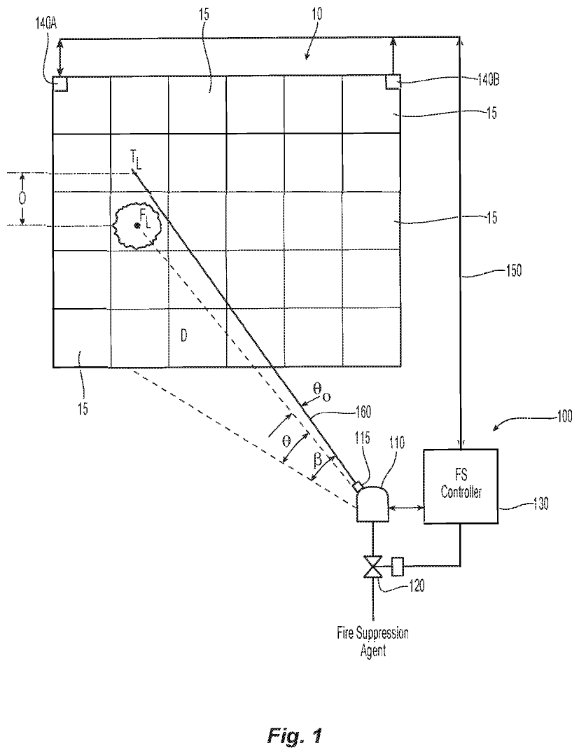

FIG. 1 depicts a fire suppression system 100. The system 100 can protect an exterior side of building 10. The building 10 may be a high-rise building that is 25 m or higher, such as 75 m or higher. Various sides of the building 10 can have a similar arrangement as system 100 to protect those sides. In case of a fire, the system 100 automatically protects a protected surface, such as cladding panels 15 that form the outer surface of building 10. In many buildings, an external fire can be disastrous because the cladding panels 15 are made of a metal composite material with combustible components, e.g., ACM cladding. The system 100 can include two or more fire detectors 140 (e.g., fire detectors 140A and 140B) that are mounted and oriented on building 10 (or another appropriate location) such that they can scan an external surface area of the cladding panels 15. Each fire detector 140A, 140B can scan the protected surface (e.g., a portion or the entire side of the building 10) such that they have overlapping fields of view but from different vantage points. Depending on the size and geometry of the building 10 and/or desired redundancy, the system 100 can have two or more fire detectors 140 that scan a side or a portion of a side of building 10.

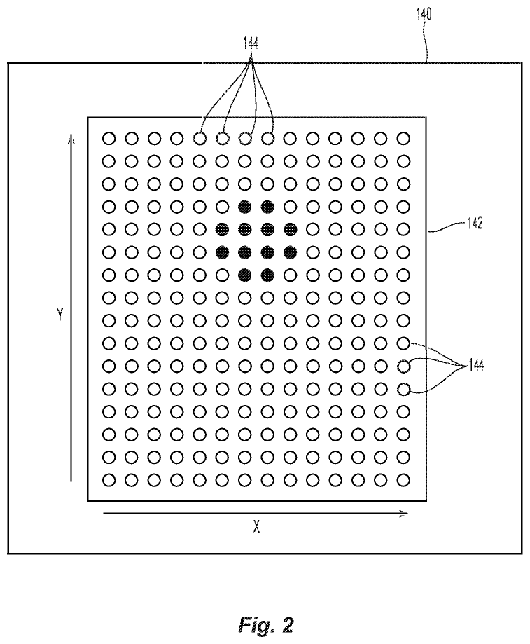

The fire detector 140 can include a sensor array to detect a fire. For example, as depicted in FIG. 2, the fire detector 140 can include a sensor 142 with an array of infrared sensor elements 144 and corresponding circuitry to detect the fire and the location of the fire on the protected surface, e.g., the horizontal (x) and vertical (y) location on the protected surface of building 10. The sensor array can have various sizes; for example, the array size can be 256 sensor elements. As depicted in FIG. 2, the sensor elements 144 that are solid indicate the presence of a fire. The fire detectors 140 can detect fires as small as 1.5 m² or smaller on the protected surface. The fire detectors 140 can detect more than one fire simultaneously. The fire detectors 140 can detect at least four fires simultaneously. As an example, the fire detector 140 can be the FLAMEVision FV300 provided by Tyco Fire Products LP. The fire detectors 140 can be used to detect a fire and the location of the fire on the protected surface.

The fire detectors 140A and 140B can be mounted on the building 10 at a predetermined distance from the building surface and at a predetermined direction and distance from each other. For example, the fire detectors 140 can be mounted up to 4 m away from the building. The distance can be greater than 4 m. The fire detector 140A and be mounted directly horizontally from fire detector 140B and at a predetermined distance from fire detector 140B, e.g., in a range of 50 m or less. The mounting direction and distance of the fire detectors 140 can vary depending on the type of the fire detector and the protected surface, e.g., the predetermined distance can be greater than 50 m. Each fire detector 140 can be mounted having a predetermined oriented to the protected surface such that the sensor has a full view of the protected surface. The fire detectors 140 can be oriented such that each fire detector 140 scans the protected surface from a different vantage point but has an overlapping field of view with at least one other fire detector 140. The values for the predetermined directions, distances, and orientations of the fire detectors 140 can be stored in the fire suppression controller 130 or are otherwise available to the fire suppression controller 130 so that the fire suppression controller 130 can accurately monitor, track, triangulate the location of, and/or calculate the size of the fire.

The installation of the fire detectors on the building 10 can be facilitated with mounting hardware that properly orients the sensor 142 to the protected surface. The mounting hardware for the fire detectors 140 can be field adjustable with respect to orientating the sensor 142 to the protected surface. To minimize problems with the installation, the mounting hardware for the fire detectors 140 can fixedly orient the fire detector 140 to the protected surface.

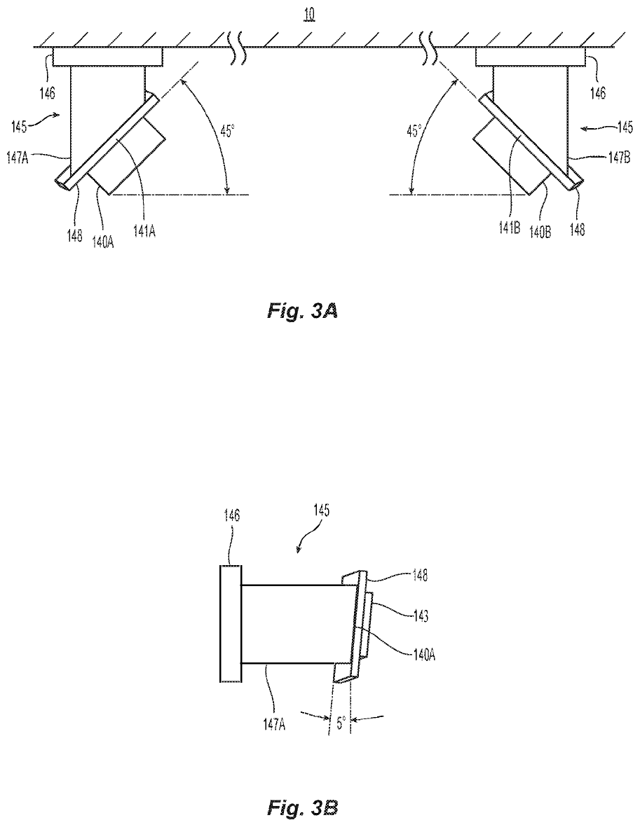

For example, as depicted in FIGS. 3A and 3B, mounting hardware 145 for the fire detectors 140 can include a rear mounting plate 146 for mounting to the building 10. Connected to the rear mounting plate 146 can be a mounting arm 147. Connected the mounting arm 147 can be a front plate 148, which provides the base for attaching the fire detectors 140.

The mounting arm 147 can be fixed such that the fire detectors 140 are oriented properly with respect to the protected surface. For example, as depicted in FIG. 3A, the mounting arm 147A can have a sloped section 141A to orient fire detector 140A toward the building 10. The mounting arm 147B can have a sloped section 141B to orient the fire detector 140B toward the building 10. The sloped sections 141A, 141B, when viewed from a horizontal plane, can have an angle with a magnitude of 45 degrees with respect to the protected surface. The sloped sections 141A and 141B can have various angles that are appropriate for the protected surface. The mounting arm 147 can have a second sloped section, e.g., sloped section 143, to orient the fire detectors 140 toward the protect surface. The mounting arm 147B can have a similar second sloped section. The second sloped section 143, when viewed from a vertical plane perpendicular to the protected surface, can have an angle of 5 degrees with respect to the protected surface. The sloped section 143 can have various angles that are appropriate (e.g., 45 degrees or another angle) for the protected surface based on, for example the distance from the building 10 (e.g., 4 m or another distance).

The mounting arm 147 may not be a separate component and can be integrated with the rear mounting plate 146 or the front mounting plate 148. The mounting hardware 145 is a single integrated unit. The rear mounting plate 146 can include a ledge that attaches to the back of the rear mounting plate 146. The ledge can be wide enough to include a level to facilitate leveling of the mounting hardware 145.

The fire detector 140 can output one or more signals that provide an indication of whether there is a fire and the location of the fire if detected. For example, as depicted in FIG. 1, the fire detectors 140A and 140B communicate with fire suppression controller 130 via communication bus 150. The communication 150 can be a wired and/or a wireless communication bus. The communication bus 150 can implement various protocols, such as Ethernet, WiFi, Bluetooth, CAN, MODBUS, or another standard or non-standard communication protocol can be used so long as the signals from fire detector 140 can be received and interpreted by fire suppression controller 150. Based on the number of sensor elements 144 (pixels) in sensor array 142 that indicate the presence of a fire, the area of the fire with respect to the protected surface can be calculated, e.g., by the fire detector 140 and/or another device such as the fire suppression controller 130.

The fire suppression controller 130 can receive the signals from the fire detectors 140 and determine the location of the fire relative to the fire monitor 110. For example, based on the x, y coordinates for the location of the fire from each of the fire detectors 140 and the known spatial relationships between the each of the fire detectors 140 on the building 10 and the location of the fire monitor 110 relative to the building 10, the distance D between the center of the fire FL and the fire monitor 110 can be calculated using triangulation. The center of the fire FL can be calculated by the fire suppression controller 130 and/or the fire detectors 140A, 140B. Based on the information from the fire detectors 140, the suppression controller automatically self-target the fire.

The fire suppression controller 130 can be connected, either directly or via communication bus (e.g., communication bus 150) to a user interface. The user interface can provide manual or partial manual override of the fire suppression system 100 to control the fire if required e.g., the user interface can have man-machine interface (for example, a mouse, trackball keyboard, joystick, or a combination thereof) for an operator to manually or semi-automatically target the fire. The user interface can provide indication of status of the system such as, e.g., the system is in a stand-by ready condition, in operation (fighting a fire), in a fault condition, or some other status. The user interface can provide a fault condition indication if the fire suppression 100 fails to properly address the fire, e.g., the system failed to activate due to a failure in a fire detector 140, the fire suppression controller 130, the valve 120, the fire monitor 110, or a failure in some other portion of the fire suppression system. The user interface can indicate that the fire suppression 100 failed to properly address the fire if the equipment operated but failed to extinguish the fire, e.g., the quantity of the fire suppression stream 160 was inadequate, the fire suppression stream 160 failed to reach the fire, or for some other reasons.

The fire suppression controller 130 can include a processing circuit including a processor and memory. The processor may be implemented as a specific purpose processor, an application specific integrated circuit (ASIC), one or more field programmable gate arrays (FPGAs), a group of processing components, or other suitable electronic processing components. The memory is one or more devices (e.g., RAM, ROM, flash memory, hard disk storage) for storing data and computer code for completing and facilitating the various user or client processes, layers, and modules described in the present disclosure. The memory may be or include volatile memory or non-volatile memory and may include database components, object code components, script components, or any other type of information structure for supporting the various activities and information structures of the inventive concepts disclosed herein. The memory is communicably connected to the processor and includes computer code or instruction modules for executing one or more processes described herein. The memory can include various circuits, software engines, and/or modules that cause the processor to execute the systems and methods described herein.

The fire monitor 110 can be connected via valve 120 to a pump or other means to provide the water/agent at the required flow and pressure to the fire monitor 110. The fire monitor 110 can supply fire suppression stream 160 to the building 10 at a high volume and a high pressure in the case of a fire. For example, the fire suppression stream 160 can be supplied at 200 GPM or greater at 60 psi (4.13 bar) or greater, such as at 220 GPM and 72 psi (4.96 bar). The system can have a capacity to provide the fire suppression stream 160 at 300 GPM for 30 to 60 minutes (e.g., the system has a storage capacity of 9000 to 18,000 gallons). The fire suppression stream 160 can be supplied at 150 to 350 GPM in a range of 58 psi (4 bar) to 116 psi (8 bar).

The fire suppression system 100 can protect a surface area on building 10 that is at least 2400 m². The fire suppression system 100 can protect a surface area on building 10 that is at least 40 m wide and at least 55 m high. The fire suppression controller 130 can cause the fire monitor 110 to provide the fire suppression stream 160 to the protected surface responsive to detecting the fire, such as in response to receiving the signals from the fire detectors 140.

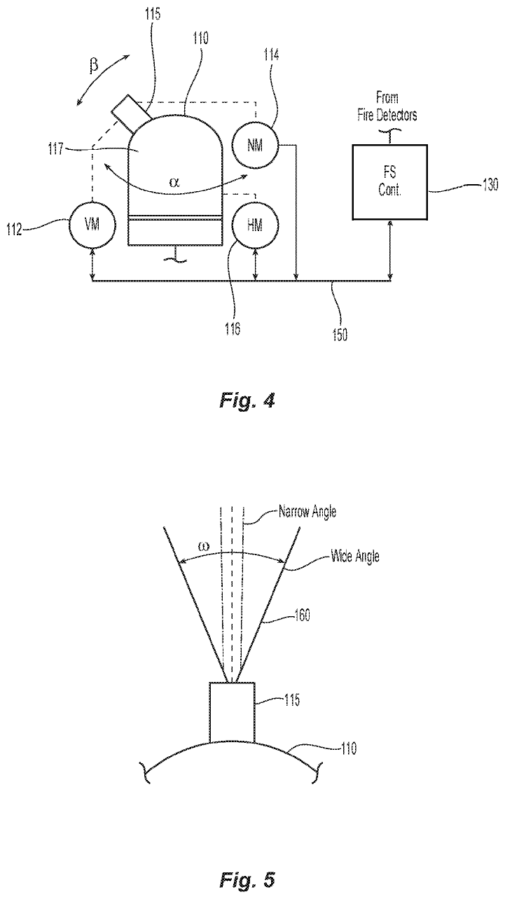

The fire suppression stream 160 can be a fire-retardant agent such as water, a chemical, a foam, or any combination thereof that can suppress or extinguish a file in the building 10. The fire monitor 110 can be controlled by the fire suppression controller 130 to direct the fire suppression stream 160 at any horizontal and vertical position on the building 10 and thus the cladding panels 15 in case the fire detectors 140 detect a fire. For example, as depicted in FIG. 4, the fire monitor 110 can position the nozzle 115 both vertically and horizontally to direct the fire suppression stream 160 at any location on the building 10. The nozzle 115 can be operated by vertical motor 112 such that the nozzle 115 can be positioned vertically as indicated by angle β (see also FIG. 1). By adjusting the angle β of the nozzle 115, the fire monitor 110 can direct the fire suppression stream 160 at any vertical elevation on the building 10. The nozzle 115 of the fire monitor 110 can also be positioned horizontally or laterally. The fire monitor 110 can include a rotatable portion 117 that is operated by horizontal motor 116 to rotate the nozzle 115 as indicated by angle α to laterally position the fire suppression stream 160 on the building 10. By adjusting the angle α on the fire suppression monitor 110, the fire monitor 110 can direct the fire suppression stream 160 horizontally along the building 10.

As depicted in FIG. 4, the vertical motor 112, the horizontal motor 116 and the nozzle motor 114 (discussed below) can be controlled by the fire suppression controller 130 via communication bus 150. The fire suppression controller can directly control one or more of the motors 112, 114, and 116. The fire suppression controller 130 can communicate with a local controller on fire monitor 110, which then controls one or more of the motors 112, 114, and 116. The fire monitor 110 can be controlled by the fire suppression controller 130 such that the coverage area of the fire suppression stream 160 is greater than the protected surface.

As depicted in FIG. 1, the fire monitor 110 can be connected to a valve 120, which supplies the fire suppression stream 160 when opened. The valve 120 can be closed when the fire suppression system 100 is not activated. The fire suppression controller 130 can automatically open valve 120, and a pump connected to the valve 120 can supply the fire suppression stream 160 to the fire monitor 110 when a fire is detected by fire detectors 140. The valve 120 can be connected to a source that holds 9,000 to 18,000 gallons of fire suppression agent. The valve 120 can be the DV-5 Deluge Valve from Tyco Fire Products LP.

The fire suppression controller 130 can sequentially target more than one fire. If more than one fire is detected, the fires can be fought in the order that they were detected. The fire suppression controller can first fight the fire that is the largest and/or most intense.

The fire suppression controller 130 can cause the fire monitor 110 to provide the fire suppression stream 160 to a location that is offset from the target location by an offset value. For example, the fire suppression stream 160 can be offset from the location of the fire such that a central portion of the fire suppression stream 160 hits the protected surface at a location that is above the location of the fire.

When a fire is detected, the fire suppression controller 130 can determine an angle θ corresponding to the straight-line vector from the fire monitor 110 to the center of the fire FL and a horizontal plane between the fire monitor 110 and the building 10. The fire suppression controller 130 may not directly target fire suppression stream 160 from the fire monitor 110 at the center of the fire FL. The fire suppression system 100 can more effectively extinguish the fire if the location on the building 10 targeted by the fire suppression stream 160, e.g., target location TL, is above the center of the fire FL by an offset value O. For example, rather than raising the nozzle 115 of fire monitor 110 to an angle that targets fire suppression stream 160 at the center of the fire FL, the angle of the nozzle 115 is increased beyond angle θ so that the fire suppression stream 160 is targeted above the center of the fire FL by the offset value O. The offset value O can correspond to an increase in the vertical discharge angle β of the nozzle 115 by an offset angle (e.g., an offset angle further offset relative to the angle θ (see FIG. 1)).

As depicted, the angle β of the nozzle 115 can correspond to a straight-line vector from the fire monitor 110 to the target location TL; for example, the fire suppression stream 160 is depicted to be hitting the target location TL in a straight-line path. The fire suppression stream may not follow a straight-line path, but rather a path dependent on one or more of the following factors: gravity, pressure of the fire suppression stream, wind conditions (e.g., speed and/or direction), distance from the building to the fire monitor (e.g., cos (θ)), distance D to the fire, and the nozzle spray angle. In some exemplary embodiments, the fire suppression controller 130 will take one or more of these factors (e.g., gravity, pressure of the fire suppression stream from a pressure sensor (not shown), wind conditions (e.g., speed and/or direction from sensors (not shown)), distance from the building to the fire monitor (e.g., cos (θ)), distance D to the fire, and the nozzle spray angle (ω) into account when calculating the target location TL and the corresponding angle β. For example, the offset value can be on at least one of a pressure of the fire suppression stream at the fire monitor, a distance from the location of the fire to the fire monitor, and a cosine of the vertical discharge angle of the fire suppression stream.

The target location TL and the corresponding angle β can be determined using a default value for θ₀, e.g., a default value in a range from 3 to 10 degrees, such as 6 degrees. By targeting the fire suppression stream 160 above the fire, the cladding panels 15 above the fire are wetted and drenched with the fire suppression stream 160, which helps prevent the spread of the fire. Along with being vertically offset, the target location TL can be horizontally or laterally offset. For example, if the fire is partly spreading laterally because of wind conditions (or for some other reason), the target location TL can be also adjusted laterally as appropriate to prevent the spread of the fire.

The fire monitor 110 can be controlled to produce an oscillating motion in the vertical direction (angle β of the nozzle 115) and/or the lateral direction of the fire suppression stream 160 (angle α) so that the fire suppression stream 160 wets and/or drenches a spray impact region. For example, the fire suppression controller 130 can control the direction of the fire suppression stream 160 from fire monitor 110 in vertical direction and/or a horizontal direction such that the fire suppression stream 160 impacts and wets/drenches an area (spray impact region) on the cladding panels 15. The fire suppression controller 130 can control the fire monitor 110 so that at least one of the vertical discharge angle and the lateral direction of the fire suppression stream 160 is oscillated around the target location so that the fire suppression stream 160 wets a spray impact region to cool the cladding to contain and/or control the fire such that the fire is extinguished and/or is prevented from growing. For example, the fire suppression stream 160 from the fire monitor 130 can be oscillated up and down and/or back and forth around the target location so that the fire suppression stream 160 impacts and wets an area (spray impact region) on the protected surface.

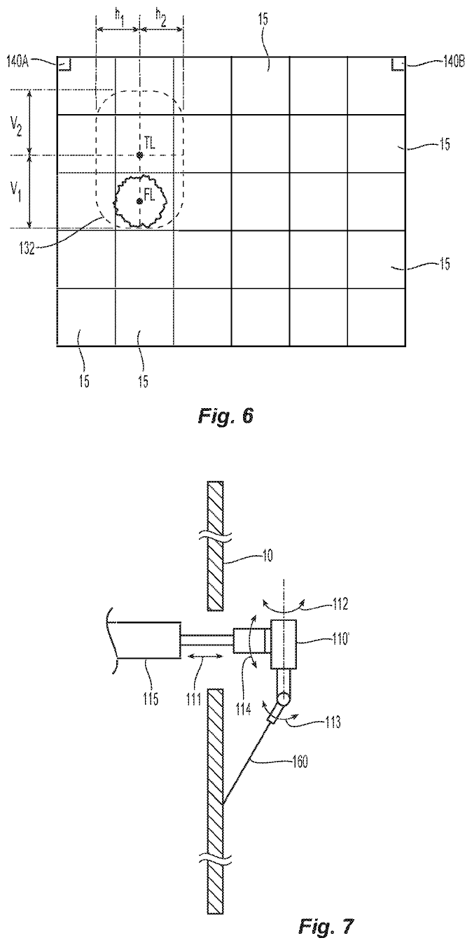

As depicted in FIG. 6, the fire monitor 110 can oscillate the fire suppression stream 160 in a vertical direction v1, v2 around the target location TL and in a horizontal direction h1, h2 around the target location TL to create a spray impact region 132. The oscillation values v1, v2 can be selected so that the spray impact region 132 extents from an area slightly below the fire area (v1 value) to an area above the fire area (v2 value) in the vertical direction and the oscillation values h1 and h2 are selected so that the spray impact region 132 extends beyond the fire area on both sides in the horizontal direction. By containing the fire in the spray impact region 132 the fire can be prevented from expanding. At least one of the spray angle, the oscillation, and the target location TL of the fire suppression stream 160 can be adjusted based on whether the fire suppression is sprayed in an upward direction or a downward direction. The magnitude of the v1 value can be equal to the magnitude of the v2 value, and the magnitude of the h1 value can be equal to the magnitude of the h2 value. One or more of the values for v1, v2, h1, h2 can depend on the wind conditions (e.g., speed and/or direction) and/or the pressure of the fire suppression stream 160. The values for v1, v2, h1, h2 can depend on whether the fire suppression stream 160 is sprayed in the upward direction or in the downward direction. For example, the fire suppression controller 130 can use default values of v1=−5±0.5 deg., v2=5±0.5 deg., h1=−2±0.5 deg., and h2=2±0.5 deg. for a system where the fire suppression stream 160 is sprayed upwards and default values of v1=−5±0.5 deg., v2=5±0.5 deg., h1=−3±0.5 deg., and h2=3±0.5 deg. for a system where the fire suppression stream 160 is sprayed downward. The frequency of the oscillation can be adjusted in real-time based on the wind conditions (e.g., speed and/or direction) and/or the pressure of the fire suppression stream 160. The oscillation angles and the oscillation frequency are functions of the area of the fire and the location D of the fire.

The fire suppression controller 130 can determine the values for v1, v2, h1, h2 such that the area of the spray impact region 132 is larger than the area of the fire by a predetermined value. For example, the area spray impact region 132 can be larger than the fire by a value in a range of 5 to 15 times the area of the fire, such as about 10 times the area of the fire. The spray angle setting of nozzle 115 can be adjusted to keep the spray impact region 132 within predetermined limits, e.g., within ±10%, of the predetermined value (e.g., 5 to 10 times the area of the fire and, more preferably, about 10 times the area of the fire).

As the distance to the fire D decreases, the oscillation pattern may increase to be able to provide the required spray impact region 132. This can reduce the efficacy of the fire suppression stream 160. The spray angle setting of the nozzle 115 can be adjusted as a function of distance D and/or the area of the fire to help reduce or eliminate the increase in the oscillation pattern. The fire monitor 110 can include a nozzle motor 114 that adjusts the spray angle setting of the nozzle 115 so that the spray angle ω of the fire suppression stream 160 can be adjusted between a wide angle and a narrow angle (see, e.g., FIG. 5). The spray angle ω can be adjusted between 5 to 60 degrees, such as between 10 to 50 degrees. The fire suppression controller 130 can adjust the spray angle setting of the nozzle 115 based on the distance D (see, e.g., FIG. 1). For example, as the distance D increases, the spray angle can be decreased, e.g., go from “fog mode” to “jet mode” based on the distance.

The spray angle setting can be decreased in a step-wise manner as the distance D increases. For example, for a distance D that is <5 m, the spray angle can be in a range of 41 to 50 degrees, such as 46 degrees; for 5 to 10 m, the spray angle can be in a range of 26 to 40 degrees, such as 31 degrees; for 10 to 20 m, the spray angle can be in a range of 16 to 25 degrees, such as 18 degrees; and for >20 m, the spray angle can be in a range of 10 to 15 degrees, such as 12 degrees.

The spray angle can be decreased continuously as the distance D increases. Spray angle curves can be implemented in a look-up-table and/or as formulas in the fire suppression controller 130 (or in a location that is accessible to the fire suppression controller 130).

The fire monitor 110 can be located at the bottom of building 10, e.g., on the ground level. Fire monitors 110 are not limited to this location and can be located at other elevations to protect the building 10. For example, the fire monitor can be located at the top the building 10. For example, the fire monitor can be disposed on the end of a retractable boom that extends out of the building 10 when there is a fire, and the fire suppression controller 130 or fire monitor 110 can adjust the parameters used to control the fire suppression stream 130 accordingly.

For example, the angles β and θ may be calculated with respect to the top of the building instead of the ground.

A retractable boom with a fire monitor may be installed in a middle portion of the building 10. In this manner more than one fire suppression system 100 can be installed to protect the side of a tall building. As depicted in FIG. 7, a fire monitor 110′ can be attached to a boom 115 with a telescopic arm 111. The fire monitor 110′ can incorporate features of the fire monitor 110′. The fire suppression controller 130 can control the arm 111 to extend outside the building 10 when a fire is detected. For example, the fire monitor 110′ can extend up to approximately 4 m outside the building. Because the fire monitor 110′ extends from the middle of the building 10, the fire monitor 110′ can be controlled to direct the fire suppression stream 160 in both an upward direction and a downward direction. For example, a component of the fire monitor 110′ (or the arm 111) can be rotated in the direction 114 to position the nozzle of the fire monitor 110′ to orient the main discharge direction of the fire suppression stream in the upward direction, downward direction, and/or the horizontal direction with respect to a vertical side of the building 10. The fire suppression controller 130 can adjust the nozzle for the fire monitor 110′ in the direction 113 to target the fire suppression stream 160 at the target location TL as discussed above. The fire suppression controller 130 can control the fire monitor 110′ to oscillate the fire suppression stream 160 in the vertical and/or horizontal directions with respect to the vertical side of building 10, e.g., by controlling the fire monitor 110′ in one or more of the directions 112, 113, and 114. The boom can be the FLAMERANGER XT TELESCOPIC BOOM from Unifire. The fire monitor 110′ can be a FORCE50 MONITOR from Unifire. The vertical and horizontal oscillations can be ±5 degrees. The fire suppression controller 130 can control the fire monitor 110 to target a fire that may be located up to 35 m horizontally from the boom installation location, up to 25 m vertically upward from the boom installation location, and/or up to 40 m vertically downward from the boom installation location. Table 1 describes various maximum spray distances and coverage areas at different discharge coefficients or K-factors K26 and K31 (flow rate=K*sqrt(pressure)) for the fire suppression spray 160.

TABLE 1

| | | | | | | Total |
|---|---|---|---|---|---|---|
| Pressure | Orifice | Flow | HR | V-Up | V-Down | Coverage Area |
| (bar) | Size | (LPM) | (m) | (m) | (m) | (m²) |
| 5 | K26 | 838 | 20 | 20 | 40 | 2400 |
| | | | 25 | 15 | 40 | 2750 |
| | K31 | 967 | 20 | 25 | 40 | 2600 |
| | | | 30 | 20 | 40 | 3600 |
| 6 | K26 | 918 | 23 | 22 | 40 | 2878 |
| | | | 28 | 17 | 40 | 3211 |
| | K31 | 1059 | 23 | 25 | 40 | 3033 |
| | | | 32 | 20 | 40 | 3800 |
| 7 | K26 | 992 | 27 | 23 | 40 | 3378 |
| | | | 32 | 18 | 40 | 3694 |
| | K31 | 1144 | 27 | 25 | 40 | 3466 |
| | | | 33 | 20 | 40 | 4000 |
| 8 | K26 | 1060 | 30 | 25 | 40 | 3900 |
| | | | 35 | 20 | 40 | 4200 |
| | K31 | 1223 | 30 | 25 | 40 | 3900 |
| | | | 35 | 20 | 40 | 4200 |

The fire suppression controller 130 can track the fire continuously via the fire detectors 140 for fluctuations in one or more of the location of the fire, the track of the fire, and the area of the fire and dynamically adjust (self-target) for these fluctuations, e.g., by making appropriate changes to one or more of the target location TL, the offset O, the distance D to the fire, the angle θ, the angle β, the angle α, the vertical and/or horizontal oscillations of the fire monitor 110, and the spray impact area 132. If the fire moves and/or increases in area, the fire suppression system 100 can automatically compensate for the changes and dynamically direct the fire suppression stream 160 to follow the flame of the fire to contain and/or extinguish the fire. After extinguishing the fire, the fire suppression controller 130 automatically shuts off the fire suppression stream 160 by shutting off the valve 120 and the fire suppression system 100 is placed in stand-by mode. The fire suppression system 100 can be retrofitted to existing buildings by connecting to existing standpipe systems that are designed in accordance with NFPA standards.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

What is claimed is:

1. An automated fire suppression system, comprising:
at least two fire detectors that scan a protected surface from different vantage points, each fire detector outputs a signal corresponding to a location of a fire responsive to detecting the fire, the protected surface disposed on at least a portion of a vertical side of a structure;
a fire monitor that provides a fire suppression stream to the protected surface; and
a fire suppression controller connected to the fire monitor and the at least two fire detectors, the fire suppression controller:
receives the signal from each fire detector;
determines a location of the fire on the protected surface relative to the fire monitor;
determines a target location for the fire suppression stream on the protected surface that is offset from the location of the fire by an offset value;
causes the fire monitor to provide the fire suppression stream to the protected surface responsive to receiving the signal from the at least two fire detectors; and
causes the fire monitor to adjust at least one of a vertical discharge angle and a lateral direction of the fire suppression stream from to direct the fire suppression stream to the target location based on a spray impact region of the fire suppression stream.

2. The system of claim 1, comprising:
the fire suppression controller determines the offset value to correspond to a target value that is above the location of the fire.

3. The system of claim 1, comprising:
the fire suppression controller determines an area of the fire with respect to the protected surface.

4. The system of claim 1, comprising:
the fire suppression controller determines an area of the fire with respect to the protected surface, and calculates a distance from the location of the fire to the fire monitor from a center of the area of the fire.

5. The system of claim 1, comprising:
the fire suppression controller determines the offset value based on at least one of a pressure of the fire suppression stream at the fire monitor, a distance from the location of the fire to the fire monitor, and a cosine of the vertical discharge angle of the fire suppression stream.

6. The system of claim 1, comprising:
the fire monitor has a nozzle with an adjustable spray angle setting, and
the fire suppression controller adjusts the spray angle setting based on a distance from the location of the fire to the fire monitor.

7. The system of claim 1, comprising:
the fire suppression controller oscillates at least one of the vertical discharge angle and the lateral direction of the fire suppression stream around the target location so that the fire suppression stream wets a spray impact region.

8. The system of claim 1, comprising:
the fire suppression controller:
oscillates at least one of the vertical discharge angle and the lateral direction of the fire suppression stream around the target location so that the fire suppression stream wets a spray impact region; and
adjusts the setting of the spray angle of the fire monitor nozzle based on the distance from the location of the fire to the fire monitor to maintain an area of the spray impact region within a predetermined limit for the area of the spray impact region.

9. The system of claim 1, comprising:
the fire suppression controller:
oscillates at least one of the vertical discharge angle and the lateral direction of the fire suppression stream around the target location so that the fire suppression stream wets a spray impact region; and
adjusts the setting of the spray angle of the fire monitor nozzle based on the distance from the location of the fire to the fire monitor to maintain an area of the spray impact region within a predetermined limit for the area of the spray impact region and as the distance from the location of the fire to the fire monitor increases, the spray angle is decreased.

10. The system of claim 1, comprising:
the fire suppression controller:
oscillates at least one of the vertical discharge angle and the lateral direction of the fire suppression stream around the target location so that the fire suppression stream wets a spray impact region; and
adjusts the setting of the spray angle of the fire monitor nozzle based on the distance from the location of the fire to the fire monitor to maintain an area of the spray impact region within a predetermined limit for the area of the spray impact region and as the distance from the location of the fire to the fire monitor increases, the spray angle is decreased in a step-wise manner as the distance increases.

11. The system of claim 1, comprising:
the fire suppression controller:
oscillates at least one of the vertical discharge angle and the lateral direction of the fire suppression stream around the target location so that the fire suppression stream wets a spray impact region; and
adjusts the setting of the spray angle of the fire monitor nozzle based on the distance from the location of the fire to the fire monitor to maintain an area of the spray impact region within a predetermined limit for the area of the spray impact region and as the distance from the location of the fire to the fire monitor increases, the spray angle is decreased continuously as the distance increases.

12. The system of claim 1, comprising:
an area of the spray impact region is greater than the area of the fire.

13. The system of claim 1, comprising:
each detector has an infrared sensor array to sense a heat signature of the fire; and
each detector is mounted to a bracket that has a first predetermined slope toward the protected surface with respect to a horizontal plane and a second predetermined slope toward the protected surface with respect to a vertical plane that is perpendicular to the protected surface.

14. The system of claim 1, comprising:
the protected surface has an area of at least 2400 m².

15. The system of claim 1, comprising:
the fire monitor is disposed at a bottom level of the structure.

16. The system of claim 1, comprising:
the fire monitor is disposed at a top level of the structure.

17. The system of claim 1, comprising:
the fire monitor is disposed at a middle level of the structure.

18. The system of claim 1, comprising:
the fire monitor is disposed on an end of a telescopic arm of a boom.

19. The system of claim 1, comprising:
the fire monitor is disposed at a middle level of the structure, and
the fire monitor targets the fire that is located at least one of up to 35 m horizontally from the boom, up to 25 m vertically upward from the boom, and up to 40 m vertically downward from the boom installation location.

20. The system of claim 1, comprising:
the protected surface has metal composite materials with combustible components.

21. The system of claim 1, comprising:
a user interface that provides an indication of a status of the system including at least one of a stand-by ready condition, fighting a fire condition, and a fault condition.

22. The system of claim 1, comprising:
the protected surface is at least 40 m wide and at least 55 m high.

23. The system of claim 1, comprising:
the fire suppression controller sequentially targets more than one fire.

24. A method of automated fire suppression, comprising:
scanning a protected surface from at least two different vantage points, the protected surface disposed on at least a portion of a vertical side of a structure;
receiving at least one signal corresponding to a fire based on the scanning;
determining a location of the fire on the protected surface relative to a source of a fire suppression stream;
determining a target location for the fire suppression stream on the protected surface, the target location offset from the location of the fire by an offset value to cool the protected surface;
providing the fire suppression stream to the protected surface responsive to the at least one signal indicating the fire is detected; and
adjusting at least one of a vertical discharge angle and a lateral direction of the fire suppression stream such that the fire suppression stream is directed to the target location based on a spray impact region of the fire suppression stream.

25. The method of claim 24, comprising:
the offset value corresponds to a target value that is above the location of the fire.

26. The method of claim 24, comprising:
determining an area of the fire with respect to the protected surface.

27. The method of claim 24, comprising:
calculating a distance from the location of the fire to the source of the fire suppression stream from a center of the area of the fire.

28. The method of claim 24, comprising:
determining the offset value based on a pressure of the fire suppression stream at the source, a distance from the location of the fire to source of the fire suppression stream, and a cosine of the vertical discharge angle of the fire suppression stream.

29. The method of claim 24, comprising:
adjusting a spray angle of the fire suppression stream based on a distance from the location of the source of the fire suppression stream.

30. The method of claim 24, comprising:
oscillating at least one of the vertical discharge angle and the lateral direction of the fire suppression stream around the target location so that the fire suppression stream wets a spray impact region.

31. The method of claim 24, comprising:
oscillating at least one of the vertical discharge angle and the lateral direction of the fire suppression stream around the target location so that the fire suppression stream wets a spray impact region; and
adjusting the spray angle of the fire suppression stream based on the distance from the location of the fire to the fire monitor to maintain an area of the spray impact region within a predetermined limit for the area of the spray impact region.

32. The method of claim 24, comprising:
decreasing the spray angle as the distance from the location of the fire to the fire monitor increases.

33. The method of claim 24, comprising:
decreasing the spray angle in a step-wise manner as the distance from the location of the fire to the fire monitor increases.

34. The method of claim 24, comprising:
decreasing the spray angle continuously as the distance from the location of the fire to the fire monitor increases.

35. The method of claim 24, comprising:
an area of the spray impact region is greater than the area of the fire.

36. The method of claim 24, comprising:
sensing a heat signature of the fire using at least two detectors having an infrared sensor array, and
each detector is mounted to a bracket that has a first predetermined slope toward the protected surface with respect to a horizontal plane and a second predetermined slope toward the protected surface with respect to a vertical plane that is perpendicular to the protected surface.

37. The method of claim 24, comprising:
the protected surface has an area of at least 2400 m².

38. The method of claim 24, comprising:
providing the fire suppression stream from a bottom level of the structure.

39. The method of claim 24, comprising:
providing the fire suppression stream from a top level of the structure.

40. The method of claim 24, comprising:
providing the fire suppression stream from a middle level of the structure.

41. The method of claim 24, comprising:
providing the fire suppression stream from a fire monitor disposed on an end of a telescopic arm of a boom.

42. The method of claim 24, comprising:
providing the fire suppression stream from a fire monitor disposed at a middle level of the structure, the fire monitor targets the fire that is located at least one of up to 35 m horizontally from the boom, up to 25 m vertically upward from the boom, and up to 40 m vertically downward from the boom installation location.

43. The method of claim 24, comprising:
the protected surface has metal composite materials with combustible components.

44. The method of claim 24, comprising:
providing an indication of a status including at least one of a stand-by ready condition, fighting a fire condition, and a fault condition.

45. The method of claim 24, comprising:
the protected surface is at least 40 m wide and at least 55 m high.

46. The method of claim 24, comprising:
sequentially targeting more than one fire.

47. An automated fire suppression system, comprising:
at least two fire detectors arranged to scan a protected surface from different vantage points, each fire detector outputs a signal corresponding to a location of a fire responsive to detecting the fire, the protected surface disposed on at least a portion of a vertical side of a structure;
a fire monitor having a nozzle with an adjustable spray angle setting to provide a fire suppression stream to the protected surface; and
a fire suppression controller connected to the fire monitor and the at least two fire detectors, the fire suppression controller:
receives the signal from each fire detector;
determines a location of the fire on the protected surface relative to the fire monitor;
determines a target location for the fire suppression stream on the protected surface;
provides the fire suppression stream to the protected surface responsive to the signal from the at least two fire detectors indicating the fire is detected;
adjusts at least one of a vertical discharge angle and a lateral direction of the fire suppression stream from the fire monitor such that the fire suppression stream is directed to the target location; and
adjusts a setting of the spray angle of the fire monitor nozzle based on a distance from the location of the fire to the fire monitor and a spray impact region of the fire suppression stream.

48. The system of claim 47, comprising:
the fire suppression controller decreases the spray angle as the distance from the location of the fire to the fire monitor increases.

49. The system of claim 47, comprising:
the fire suppression controller decreases the spray angle in a step-wise manner as the distance from the location of the fire to the fire monitor increases.

50. The system of claim 47, comprising:
the fire suppression controller decreases the spray angle continuously as the distance from the location of the fire to the fire monitor increases.

51. The system of claim 47, comprising:
the fire suppression controller calculates the distance from the location of the fire to a center of the area of the fire.

52. The system of claim 47, comprising:
the fire suppression controller determines an area of the fire with respect to the protected surface.

53. The system of claim 47, comprising:
the target location is offset from the location of the fire by an offset value and the offset value corresponds to a target value that is above the location of the fire.

54. The system of claim 47, comprising:
the target location is offset from the location of the fire by an offset value and the offset value corresponds to a target value that is above the location of the fire, the offset value is based on at least one of a pressure of the fire suppression stream at the fire monitor, the distance from the location of the fire to the fire monitor, and a cosine of the vertical discharge angle of the fire suppression stream.

55. The system of claim 47, comprising:
the fire suppression controller oscillates at least one of the vertical discharge angle and the lateral direction of the fire suppression stream around the target location so that the fire suppression stream wets a spray impact region.

56. The system of claim 47, comprising:
the fire suppression controller oscillates at least one of the vertical discharge angle and the lateral direction of the fire suppression stream around the target location so that the fire suppression stream wets a spray impact region, the adjustment of the setting of the spray angle of the fire monitor nozzle maintains an area of the spray impact region within a predetermined limit for the area of the spray impact region.

57. The system of claim 47, comprising:
the fire suppression controller oscillates at least one of the vertical discharge angle and the lateral direction of the fire suppression stream around the target location so that the fire suppression stream wets a spray impact region, the adjustment of the setting of the spray angle of the fire monitor nozzle maintains an area of the spray impact region within a predetermined limit for the area of the spray impact region, an area of the spray impact region is greater than the area of the fire.

58. The system of claim 47, comprising:
each detector has an infrared sensor array to sense a heat signature of the fire; and
each detector is mounted to a bracket that has a first predetermined slope toward the protected surface with respect to a horizontal plane and a second predetermined slope toward the protected surface with respect to a vertical plane that is perpendicular to the protected surface.

59. The system of claim 47, comprising:
the protected surface has an area of at least 2400 m².

60. The system of claim 47, comprising:
the fire monitor is disposed at a bottom level of the structure.

61. The system of claim 47, comprising:
the fire monitor is disposed at a top level of the structure.

62. The system of claim 47, comprising:
the fire monitor is disposed at a middle level of the structure.

63. The system of claim 47, comprising:
the fire monitor is disposed on an end of a telescopic arm of a boom.

64. The system of claim 47, comprising:
the fire monitor is disposed at a middle level of the structure, and the fire monitor targets the fire that is located at least one of up to 35 m horizontally from the boom, up to 25 m vertically upward from the boom, and up to 40 m vertically downward from the boom installation location.

65. The system of claim 47, comprising:
the protected surface has metal composite materials with combustible components.

66. The system of claim 47, comprising:
a user interface that provides an indication of a status of the system including at least one of a stand-by ready condition, fighting a fire condition, and a fault condition.

67. The system of claim 47, comprising:
the protected surface is at least 40 m wide and at least 55 m high.

68. The system of claim 47, comprising:
the fire suppression controller sequentially targets more than one fire.

69. A method of automated fire suppression, comprising:
scanning a protected surface from at least two different vantage points, the protected surface disposed on at least a portion of a vertical side of a structure;
receiving at least one signal corresponding to a fire based on the scanning;
determining a location of the fire on the protected surface relative to a source of a fire suppression stream;
determining a target location for the fire suppression stream on the protected surface;
providing the fire suppression stream to the protected surface responsive to the at least one signal indicating the fire is detected;
adjusting at least one of a vertical discharge angle and a lateral direction of the fire suppression stream such that the fire suppression stream is directed to the target location and cools the protected surface; and
adjusting a spray angle of the fire suppression stream based on a distance from the location of the fire to the fire monitor and a spray impact region of the fire suppression stream.

70. The method of claim 69, comprising:
decreasing the spray angle as the distance from the location of the fire to the fire monitor increases.

71. The method of claim 69, comprising:
decreasing the spray angle in a step-wise manner as the distance increases.

72. The method of claim 69, comprising:
decreasing the spray angle continuously as the distance increases.

73. The method of claim 69, comprising:
calculating the distance from the location of the fire to the source of the fire suppression stream from a center of the area of the fire.

74. The method of claim 69, comprising:
determining an area of the fire with respect to the protected surface.

75. The method of claim 69, comprising:
the target location is offset from the location of the fire by an offset value and the offset value corresponds to a target value that is above the location of the fire.

76. The method of claim 69, comprising:
the target location is offset from the location of the fire by an offset value and the offset value corresponds to a target value that is above the location of the fire, the offset value is based on a pressure of the fire suppression stream at the source, a distance from the location of the fire to source of the fire suppression stream, and a cosine of the vertical discharge angle of the fire suppression stream.

77. The method of claim 69, comprising:
oscillating at least one of the vertical discharge angle and the lateral direction of the fire suppression stream around the target location so that the fire suppression stream wets a spray impact region.

78. The method of claim 69, comprising:
oscillating at least one of the vertical discharge angle and the lateral direction of the fire suppression stream around the target location so that the fire suppression stream wets a spray impact region, and
adjusting the spray angle of the fire suppression stream based on the distance from the location of the fire to the fire monitor to maintain an area of the spray impact region within a predetermined limit for the area of the spray impact region.

79. The method of claim 69, comprising:
an area of the spray impact region is greater than the area of the fire.

80. The method of claim 69, comprising:
sensing a heat signature of the fire using at least two detectors having an infrared sensor array; and
each detector is mounted to a bracket that has a first predetermined slope toward the protected surface with respect to a horizontal plane and a second predetermined slope toward the protected surface with respect to a vertical plane that is perpendicular to the protected surface.

81. The method of claim 69, comprising:
the protected surface has an area of at least 2400 m².

82. The method of claim 69, comprising:
providing the fire suppression stream from a bottom level of the structure.

83. The method of claim 69, comprising:
providing the fire suppression stream from a top level of the structure.

84. The method of claim 69, comprising:
providing the fire suppression stream from a middle level of the structure.

85. The method of claim 69, comprising:
providing the fire suppression stream from a fire monitor disposed on an end of a telescopic arm of a boom.

86. The method of claim 69, comprising:
providing the fire suppression stream from a fire monitor disposed at a middle level of the structure, and
the fire monitor targets the fire that is located at least one of up to 35 m horizontally from the boom, up to 25 m vertically upward from the boom, and up to 40 m vertically downward from the boom installation location.

87. The method of claim 69, comprising:
the protected surface has metal composite materials with combustible components.

88. The method of claim 69, comprising:
providing an indication of a status including at least one of a stand-by ready condition, fighting a fire condition, and a fault condition.

89. The method of claim 69, comprising:
the protected surface is at least 40 m wide and at least 55 m high.

90. The method of claim 69, comprising:
targeting more than one fire sequentially.
